(19) United States
(12) Patent Application Publication
(10) Pub. No.: US 2005/0209916 A1
(43) Pub. Date: Sep. 22, 2005

(54) Customer Stock incentives programs

(76) Inventors: Robert Longman, Chicago, IL (US); Sophia C. Li, Chicago, IL (US)

Correspondence Address: ROBERT LONGMAN & SOPHIA C. LI, UNIT #145, 1749 GOLF ROAD, MOUNT PROSEPCT, IL, 60056, US

(21) Appl. No.: 10/803,321

(22) Filed: Mar. 18, 2004

(51) Int. Cl. G06F 17/60

(52) U.S. Cl. 705/14

(57) ABSTRACT

The present invention provides a fresh method for generating customer loyalty through stock related incentives. Instead of the traditional stock incentive plans for only employees and investors, the present invention stresses the crucial importance of customers in an increasingly complicated business world. In a reward program dedicated to customers, customers will receive a set amount of stock options (or stocks) according to their revenue generating potentials. The number of stock options (or stocks) will continue to be distributed to customers throughout the business reporting cycle. (quarterly, semi-annually, or annually) based on each customer's contribution in generating corporate revenues. Overtime, customers will become significant stockholders of a company, and they will continue to reward the company with their loyalty not just through words, but through actions given the fact that the future growth and profit potential of the company are of personal interests to the customer stockholders.

### FIELD OF INVENTION

The invention relates to customer reward and incentive program and more particularly to stock issuing online and offline companies.

### BACKGROUND

Stock incentives are commonly used as stimulus for company employees. When it comes to reward customer loyalty, programs contrast sharply. One thing is for sure; the concept of rewarding customers in order to retain customer loyalty has always been in the minds of business owners and business management teams.

In the past, most business transactions did not involve direct business-to-consumer relationships. Rather, consumers purchase goods through dealers. Unarguably, the time has changed with the rise of the Internet and E-commerce. Businesses are now more desirably marketed on the Net, with lower operating costs, 24/7 non-stop operations, and drastically improved efficiency. Large or small, old or new, companies have been making transformations from the physical locations to cyberspace settings. Businesses are now closer to their customers than we could ever imagine a decade ago. Consumers, on the other hand, have discovered a time saving cannel to search products and services and compare values and experiences across hundreds if not thousands of competitors. In other words, consumers are given the instrument of becoming increasingly sophisticated. In the age of the Internet, attracting potential customers grows to be undoubtedly complex and difficult. Nevertheless, the ability to keep existing customers is even a greater challenge to business owners and management teams. Customer reward has been an effective method for retaining customer loyalty in the past, but with fierce competitions in the game, the costs of the customer rewards are destined to climb and slice into company profits. And even then, there is still no assurance that customers will not switch to other competitors for more enticing offers.

What does customers really want when traditional reward points are no longer satisfying? What could businesses really offer that might build a long-term alliances between themselves and their customers? How to build bonds between businesses and consumers while it is virtually infeasible to increase the stake of the customer rewards? How to ease the possibility of program imitations by other competitors by creating a first-mover advantage?

In the past, customers purchase stocks of their favorite companies because they believe in the profit and growth potentials of these companies. Conversely, it is time for companies to distribute their shares of ownerships to their customers because companies' futures are indispensably tied to the loyalty of their customers. Competitions demand business owners to take active measurements. Customer stock incentive programs are the waves of the future.

### SUMMARY OF THE INVENTION

The present invention provides a fresh method for generating customer loyalty through stock related incentives. Instead of the traditional stock incentive plans for only employees and investors, the present invention stresses the crucial importance of customers in an increasingly complicated business world. In a reward program dedicated to customers, customers will receive a set amount of stock options (or stocks) according to their revenue generating potentials. The number of stock options (or stocks) will continue to be distributed to customers throughout the business reporting cycle (quarterly, semi-annually, or annually) based on each customer's contribution in generating corporate revenues. Overtime, customers will become significant stockholders of a company, and they will continue to reward the company with their loyalty not just through words, but through actions given the fact that the future growth and profit potential of the company are of personal interests to the customer stockholders.

### BRIEF DESCRIPTION OF THE DRAWINGS

Not Applicable.

### DESCRIPTION OF PREFERRED EMBODIMENTS

As used herein the following terms have the meaning given below:
1. “Customer”—means a person, a business entity, a non-business entity, or any combination of such.
2. “Stock Incentives”—refers to stock options plan, actual stock offerings, or any other incentive plan that's related to stocks.
3. “Stock Options”-refers to only the call options in customer incentive programs. Call option gives the option holder the right to purchase a set amount of stocks at a predetermined price called exercise price, but the option holder is not obligated to exercise the stock options if the stock price drops below or equal to the exercise price. Stock options usually give option holders the chance to purchase actual stocks at below market price.
4. “First Mover Advantage”—refers to the natural advantage by being the first to make the same or similar move.
5. “Natural Monopoly”—refers to a single dominant business entity in an industry lacks of any noticeable or credible competitors not due to its monopolizing practice, but due to the nature of the industry in accordance with economic behaviors.
6. “Holding Period”—refers to the time or period that a customer will not be allowed to sell or transfer his/her/its stocks of the company.
7. “Reward Ratio” or “Reward Percentage”—refers to the number of stock options (or stocks) a customer will receive in comparison to his/her/its actual revenue contribution to a company.
8. “Market Capitalization”.—refers to a company's market value by multiplying the company's total outstanding shares to the company's current share price on the market.

### DETAILED DESCRIPTION OF THE INVENTION

The beauty of the present invention is that customer stock incentive plan will work under any economic setting. Whether an industry is dominated by a monopoly or natural monopoly, shared by oligopolies, or over-crowed by immense competitions, a business entity first adopts the concept of customer stock incentive plan will gain competitive advantage over others.

How to Break into an Industry Where There is a Strong Monopoly

Although monopolizing or attempting to monopolize an industry is strictly prohibited by law, there are industries where monopoly power is not obtained through unlawful practices. Rather, their dominant positions are guaranteed by the fundamental nature of those industries, and we called them “natural monopolies” since their monopoly status cannot be challenged by anti-trust laws. Finding a break point to compete under such circumstances is usually viewed as impossible; nevertheless, customer stock incentive plans as we believe will provide the long-waited opportunity for other small competitors for expansions.

For instance, online exchanges are places where people trade with each other for goods and services. The nature of such industry demands a centralized marketplace for buyers and sellers. It is understood that the power of such a marketplace arises from the network effect associated with the vast number of market participants. Buyers will elect to go to a marketplace where there are abundant choices, and sellers will choose to operate in a marketplace where there are plentiful potential customers for high prices of goods and services and greater liquidity associated with large numbers of buyers. Once a marketplace has established its dominance, new buyers and sellers will be drawn to the marketplace for the reasons stated above. It is highly unlikely for buyers or sellers to forgo such an established marketplace to join a newly established exchange since drawbacks far outweighs any potential benefits derived from such a shift. Moreover, any attempt to reward such shift is unquestionably futile. New exchanges cannot possibly afford heavy rewards for new customers; then again, there is no guarantee that the customers will not switch back to the established exchange after collecting the rewards.

Stock Incentives offer customers the only reason and the sense of purpose to switch and stay with newly established exchanges. In general, buyers' loyalty concentrates on value and experiences of online exchange transaction with sellers. In other words, buyers' loyalty towards an exchange extends only as far as the presence of good value on goods and services they seek. To get both sellers and buyers to switch away from their preferred exchange, the key is to entice sellers and not necessary buyers. Sellers have the power to draw migration of buyers from the established exchange to new exchanges. However, sellers wanted more than just a parcel of conventional rewards; they desire and deserve a part of the ownerships. Although each stock incentive program will vary, we can explore the possibilities. For example, the new exchange can offer a set amount of actual stocks of the company, say 100 shares to each customer to make the switch. Once the initial stocks are offered, customers will conduct trades on the new exchange. After six months of trial, different customers concluded different amount of transactions and transaction amount. Assume the company distributes stock options based on the number of transactions; then each transaction will allow customer one share of stock option (or any other ratio that may seem appropriate). More specifically, if a seller conducted 1000 transactions in the past six months, then at the end of the sixth month, this seller is entitled to stock options that will allow him to purchase 1000 shares of the company stock at a predetermined price if he decides to exercise the option. On the other hand, if the company distributes stock options based on the amount of total transactions occurred; then every $100 will convert to one share of stock options (or any other ratio that may seem appropriate). More explicitly, if a seller conducted six-month-transaction totaled $100,000, then this seller is entitled to stock options that will give him the opportunity to purchase 1000 shares of the company stock if he chooses to exercise the option.

In essence, the more transactions or transaction amount conducted, the more stock options or stocks a participant will receive as payment of such a contribution. Participants are given the inspiration to energetically cultivate the exchange when their personal interests are strongly attached to the expansion of the exchange. More importantly, participants have no incentive to revisit the old exchange since such a move will adversely affect the value of their personal shares in the new exchange.

How to Compete in an Oligopoly Environment

Oligopoly defines a market situation in which each of a few player affects but does not control the market. Good examples will be the premium TV networks industry and the automobile industry. In an oligopoly environment, pricing is not a competitive factor because consumers are given the limited selections of choosing one or the other provider. There is no incentive for players to cut prices since a price war only benefits consumers but will not deliver greater market share for companies. For better illustration, taking cable network and dish network as an example. Both are operating to provide premium TV programs with different signal transmitting methods. The TV networks they carry are the same, so does the pricing although each occasionally offers limited-time promotions to attract new customers. The problem is that consumers are making frequent switches from one provider to another according to these promotional pricing. Ultimately, both companies gain and lose customers with no significant grow in market shares. If one of the providers, say cable networks, implements customer stock incentive programs for its existing customers, then the cable customers may not have the interest to switch to dish network services if the dish offers a six months promotional pricing. On the contrary, if cable networks offer a six months promotional pricing, dish customers will still make a switch to take an advantage of the cable offering since dish customers' loyalty is built on only pricing and not ownerships. Once dish customers make switches, cable networks provider will enroll these new customers in its stock incentive program. Overtime, cable networks will pick up more and more market share and lead ahead of dish networks.

How to Advance in a Highly Competitive Environment

For most forms of industries, competitions not only drive down revenues and profits, but also threaten mere existences of many corporations. Companies in highly competitive industries such as telecommunications, Internet services, and online travel agencies are overwhelmed by mounting competitions. Exceeding the rest may not surpass the basic instinct for survival as the core objective for companies in those industries.

Taking telecommunication industry as an example, the only way to compete so far is for companies to cut prices on minutes in order to attract customers. In many cases, marginal revenues are reduced to match exactly to marginal costs on each minute. Adding rising costs of advertising, most companies are operating at losses. Sooner or later, accumulations of losses will lead to nothing other than insolvencies. Nevertheless, consumers are known to switch operators actively in seeking the next best deal. As technologies advances, switching becomes quicker and easier.

One way to avoid the fate of insolvency is to merge with other competitors into a larger operator and continue with mergers and acquisitions until there are only few players left in the game. Though chances of governmental approval of potential oligopolies in the telecommunication industry are slim since the mandatory order on breakdown of the telecom giant AT&T in the late 80's.

Another method of surviving and even thriving may be accomplished by the adoption of customer stock incentive programs. For instance, a cellular phone provider can issue a set amount of stock options when a customer initially signs up with the program. For every year the customer stays with the program, he/she/it will continue to receive a set number of stock options. Or the customer will receive stock options based on usage. In addition, every referral will grant them with even more stock options. In any business as well as telecommunication, companies will operate as long as their marginal revenues are greater than or equal to their marginal costs. Conversely, no company will operate if its marginal cost exceeds its marginal revenue. In a highly competitive environment, companies' marginal revenues will eventually converge with marginal costs. Naturally, pricing set by each operator will also converge. Operating on large volume (in other words, attracting vast numbers of customers) is a key to maintain such a balance between marginal revenues and marginal costs. In a highly competitive environment, the winner will be the one that can stand the test of time. Customer stock incentive programs allow companies to capture and retain the vast numbers of customers needed for survival and concluding advancement.

The other good example will be the online travel booking agencies. Online travel booking industry is highly competitive because pricing has been the only method of competition. However, prices quoted by one agency may not be any different from the quote submitted by another agency since the quotes are usually from the same network of databases. In fact, we can take expedia.com and cheaptickets.com for comparison on airline tickets. A round trip United Airline tickets from Chicago to New York costs $284.20 on expedia.com also costs $284.69 on cheaptickets.com. There is almost no difference in pricing, so why should a customer prefer one versus another. Of course, competitions are more than just those two mentioned above—hotel.com, travelocity.com, priceline.com, orbitz.com, and etc. All these companies are in the business of utilizing the same booking network; it is obvious that one needs more than just advertisements to attract and retain customers. Using customer stock incentive program, an online travel agent can issue stock options based on the total amount spent by a particular customer. For instance, if a customer spent $100,000 in a year, with the reward ratio of 1 to 100, then he/she/it will receive stock options equivalent to 1000 shares of stocks. Once customers are given the ownership of the company at below market price per share, they will have the incentive to purchase airline tickets, hotel rates, and travel packages from the agent that is partially owned by them, given the fact that pricing from various competitions are extremely similar. The more businesses their preferred agent conducts, the higher the stock price is expected. Both the agent and its customers will benefit from this mutual alliance. Consequently, this preferred agent who adopts customer stock incentive program earns the opportunity to come ahead against all of its competitors.

How to Improve Revenue and Build Customer Alliances at the Same Time

The advantage of implementing a customer stock incentive program not only is applicable to companies that wish to gain market share, but also pertinent to industry leaders that are interested in growing corporate revenues while building strong alliances with customers. There is absolutely no rationale to sacrifice corporate revenue objective in order to build customer loyalty. Both objectives can be met and without conflicts. For instance, Yahoo.com is the industry leader in online advertising and search engines. However, Yahoo does not charge customers for using its search services because it does not want to drive away customers. With millions of users worldwide, Yahoo is forgoing enormous potential revenue each year. Yahoo's market capitalization should far exceed that of ebay's if it decides to charge for its search engine and other free services. How to retain customers while growing revenue at the same time is the key to elevated success for current market leaders. Expressly, a market leader can utilize the power of customer stock incentive program to deliver prominent revenue results. If a market leader charges its customers for its existing services, it should compensate customers with stock options. If a customer is given the ownership of its preferred company, it is unlikely that the customer will leave for a different service provider since any fee paid to the company is in turn rewarding the customers in the form of actual ownership.

### CONCLUSION

By using customer stock incentive programs, any company can break into a monopolistic environment, fruitfully compete in an oligopoly situation, and effectively advance in highly competitive surroundings.

Customer Stock Incentives Program utilizes the power of ownership to reach and retain extraordinarily wide rages of consumers under dynamic economic settings. It is also a cost-efficient and result-oriented method for improving revenue and customer relations for market leaders. Although each customer stock incentives program will vary, several key points need to be observed carefully in order to productively exploit the prospective benefits.

First Mover Advantage

While customer stock incentives programs give an implementer competitive advantage, being the first to adopt such a program is of crucial importance. One of the attractiveness of customer stock incentives programs is that the program cannot be successfully imitated by a second user. Everything being equal, it is logically unsound for any consumer to forgo stock ownership in the first company in exchange for stock ownership in a second company, since such a move will not deliver excess benefit for the customer.

Stock Price of the Leading Competitor

It is easy to comprehend the effect of the stock price of the leading competitor on a customer stock incentives program. The higher the stock price of the competitor, the more attractive is the switch. If consumers are able to observe the value of the leader stock, it will be easier for them to perceive the value of the stock incentive program they enroll in. If the price of the leader stock is performing extremely well and growing at a fast pace, consumers will gladly enroll in the program because they recognize the growth potential of the new company will deliver outstanding personal gain. Conversely, if the leader stock in a dying industry is plunging, there is no motivation for consumers to join a competitor's stock incentive program due to its futile nature.

Holding Period

It is recommended that a stock incentives program should incorporate a holding period determined by the issuing company. In other words, once stock options are exercised, those stocks cannot be sold for a set period. Even though customer stock incentives program may work without such a holding period in certain industries, it is sensible for companies to employ such a period in order to stabilize stock prices and to avoid frequent switches by customers to other competitors that offer similar customer stock incentives programs. For instance, a customer holds stock options for 1000 shares of company X stock at an exercise price of $20 per share. Upon exercise, the market price of company X stock is trading at $30. Without a holding period, the customer can exercise her stock options to buy company X stock at $20 per share and sell them immediately at $30 per share on the market. The customer will take a gain of $10,000 [1000 shares*($30-$20) per share)] and accept no obligations to remain with company X. In fact, the customer can enroll in company X's competitor company Z's customer stock incentives program uninterruptedly if there is no holding period restrictions. The significance of such a holding period is quite obvious.

Customer Stock Incentive Programs serves as a powerful tool for building customer alliances in a complicated business environment and are more cost effective than advertisements.

It should be understood that while various embodiments of the invention have been described, those skilled in art could make various changes in form, detail, and design without departing from the principle, spirit, and scope of the invention described herein. Applicant's invention is limited only by the scope of the appended claims.

1. A method of rewarding or building customer loyalty in which a) a company (or a stock issuing business entity) grants its customers with set amount of stock options (or stocks); b) the initial stock option (or stocks) offering quantity for each customer will be based on each customer's revenue generating potential or any other method or combination of methods as dictated by said company or said business entity; c) said company (or said business entity) will record each customer's revenue contribution to the company (or said business entity) during each reporting cycle (quarterly, semi-annually, or annually); d) each customer will be granted additional stock options (or stocks) based on his/her/its revenue contribution to said company (or said business entity); e) reward ratio affects the amount of stock options (or stocks) a customer will receive; f) the more contribution a customer gives, the more stock options (or stocks) he/she/it receives; g) overtime, those customers made momentous contributions to the revenue will become significant shareholders of said company (or said business entity); h) said company (or business entity) will be able to reward and retain valuable customers while growing itself at the same time; i) there is a first mover advantage in adopting stock incentive plans for customers; j) said method contains a holding period determined by the said company (or said business entity) so that customers will not be able to sell the company stocks in order to stabilize stock prices and to avoid customers making frequent switches to other companies.

2. A method as in claim 1 wherein said stock incentive plan (or stock rewarding plan) is for publicly traded companies.

3. A method as in claim 1 wherein said stock incentive plan (or stock rewarding plan) is for privately held companies.

4. A method as in claim 1 wherein said companies (or business entities) are online companies.

5. A method as in claim 1 wherein said companies (or business entities) are traditional offline companies.
